(19) United States
(12) Patent Application Publication
(10) Pub. No.: US 2024/0379972 A1
(43) Pub. Date: Nov. 14, 2024

(54) IMPROVED PROCESS FOR PRODUCING A POLAR PLATE

(71) Applicant: Hochschule RheinMain University of Applied Sciences Wiesbaden Rüsselsheim, Wiesbaden (DE)

(72) Inventors: Yannick Arz, Buerstadt (DE); Martin Gleichmann, Ruesselsheim (DE); Yannic Kessler, Kriftel (DE); Birgit Scheppat, Trebur (DE)

(21) Appl. No.: 18/577,999

(22) PCT Filed: Jul. 7, 2022
(86) PCT No.: PCT/EP2022/068923

§ 371 Date: Jan. 9, 2024

(30) Foreign Application Priority Data
Jul. 9, 2021 (EP) 21184782.7

(51) Int. Cl. H01M 8/0228; B22F 10/18; B22F 10/20; B33Y 10/00; B33Y 80/00; C22C 38/06; C22C 38/12; H01M 8/0258; H01M 8/10; H01M 8/18

(52) U.S. Cl. CPC H01M 8/0228; B22F 10/18; B22F 10/20; B33Y 10/00; B33Y 80/00; C22C 38/06; C22C 38/12; H01M 8/0258; H01M 8/188; B22F 2301/35; B22F 2998/10; B22F 2999/00; H01M 2008/1095

(57) ABSTRACT

A process for producing a polar plate for fuel cells and/or redox flow batteries, comprising applying layers to produce a blank, wherein a composite formed of print material is printed layer-by-layer through a nozzle (extruder) using a fused filament fabrication (FFF) process or a fused granular fabrication (FGF) process and applied to a work plane to produce the blank of the polar, and sintering, wherein the blank of the polar plate is heated, with the temperatures during sintering remain below the melting temperature of the print material, so that the form (shape) of the workpiece is retained and to produce a finished polar plate.

The present invention relates to an improved process for producing a polar plate in particular for the use thereof for a fuel cell or redox flow battery.

### PRIOR ART

A fuel cell is an electrochemical cell which converts the chemical energy of a fuel into electricity through an electrochemical reaction.

Various types of fuel cells exist.

One specific type of fuel cell is the proton exchange membrane fuel cell (PEM fuel cell). In a fuel cell, a continuously supplied fuel (for example hydrogen H₂) reacts with an oxidizing agent (for example oxygen O₂). This produces water (H₂O), electricity and heat. This electrochemical reaction is also referred to as “cold combustion”and is particularly efficient. FIG. 1 shows a schematic construction of such an already known fuel cell. In addition to membranes, electrodes and a catalyst, what are known as polar plates are also provided in these fuel cell types.

Similarly to a fuel cell, a redox flow battery is an electrochemical cell which stores or dispenses electrical energy with the aid of an electrolyte. The primary factor for the power is the size of the exchange membrane, while the capacity is primarily defined by the size of the tanks. A particular feature of redox flow batteries is their low risk of fire and high cycling stability. The construction of the redox flow battery is similar to the construction of a PEM fuel cell consisting of an exchange membrane, the associated tanks and pumps and also polar plates.

These electrically conductive plates (polar plates) serve to conduct the electric current as electrodes and additionally guide a fluid through correspondingly arranged flow channels. Fuel cells or fuel cell stacks and redox flow stacks are constructed from membrane electrode units and polar plates arranged one above the other in alternating fashion. The polar plates serve to supply the electrodes with reactants and to cool the fuel cell stack. For the maintenance of the electrochemical reaction in the fuel cell stack, polar plates apply the electrodes formed on the anode side to the cathode side of the adjacent cell advantageously with as little electrical resistance as possible. This means that, in addition to a good bulk conductivity, the contact transfer resistances should in particular also be as low as possible. These polar plates are core elements of every PEM fuel cell stack and redox flow battery stack. They regulate the supply of hydrogen and air or, in the case of the redox flow battery, of electrolytes, and also in the case of the fuel cell the discharge of water vapor and in both cases the release of thermal and electrical energy. The configuration of their flow field has a significant influence on the degree of efficiency of the entire unit. Polar plates can in this case differ markedly from one another—both with regard to their size and in terms of their production method.

For the choice of material and the configuration of the polar plates, in addition to thin, structure-embossed metal foils, which generally require corrosion protection, and pure graphite plates, which do exhibit a high chemical resistance and good contact transfer resistances but are laborious to process, it is also possible to use plates made of highly filled graphite-based thermoplastic or curable composites, which combine the good functional properties of graphite with a simpler and more cost-effective design.

The following can in principle be stated: The larger the plates, the higher the current strength of an individual cell, since the effective surface area of the polymer electrolyte membranes (PEMs) also corresponds to their size. The more hydrogen that can be converted per unit of time, the higher the current flow. These plates, which are optimized for a high conversion rate, have a complex structure of flow channels for liquids and conduits for the transfer of gases.

Various processes have been proposed for the production of polar plates.

A first production process is the burr-free and stress-free etching of polar plates. In the etching process, metal is removed simultaneously. For instance, complex channels or flow fields can be etched on both sides of the polar plate to 0.025 mm—with a precision of ±0.025 mm. The size and shape of the channels varies. Distributors, consumers and interface features can be easily incorporated. One particular etching process is photochemical etching. In this case there are no mechanical or thermal stresses on the polar plates that could adversely affect the connection of the stacks. Etched polar plates are typically produced from 316 or 904 grade stainless steels. However, exotic and hard-to-work metals can also be etched, for example titanium for a lower weight and maximum corrosion resistance.

Alternatively, the polar plates are produced for example using CNC machining and punching. However, this has the disadvantage that the flatness of the polar plate is impaired and stresses and burrs are caused.

Documents DE 10 2017 201 703 A1 and WO 2008/049099 A1 disclose material proposals and design options for bipolar plates, where the polyhydroxyalkanoates proposed in WO 2008/049099 A1 can decompose in deionized water, in particular under the influence of heat.

A process that has not been used to date for polar plates is the “fused filament fabrication” (FFF) process or the “fused granular fabrication” (FGF) process. Here, a filament usually consisting on the basis is pressed through a nozzle or, in the case of the FGF process, a granular material is pressed through a nozzle by means of an extruder screw, melted and a component is constructed in a layer structure through positioning of the movable nozzle or via a displaceable table or a combination of the two. Due to the typical characteristics of thermoplastics, these materials have very low electrical and thermal conductances. Accordingly, it has not been possible to date to produce effective hydrogen fuel cells or redox flow battery stacks using an FFF printing process or an FGF printing process.

### OBJECT

The object of the present invention is to provide an improved process for producing polar plates, which eliminates the disadvantages in the prior art.

### Achievement of the Object

This object is achieved according to the invention by a process as claimed in claims 1 to 11.

As with any 3D printing process, the fundamental prerequisite here is also a printable, digital 3D model. This model is broken down by a computer program into a multiplicity of layers (slices) which then form the basis of the actual production process. The process according to the invention for producing the polar plate is carried out on the basis of this previously generated model.

The polar plate produced can be a monopolar plate or a bipolar plate.

The process comprises the following steps:

### I. Applying the Layers to Produce a Blank

A composite formed of print material with an optional binder is applied layer-by-layer onto a work plane. Delivery is preferably via an extruder. The extruder is a heatable nozzle. The material used for printing is heated by the extruder until it liquefies or melts. This liquid or molten material is applied to the work plane by the extruder according to the layers of the 3D model. As soon as the material cools, it quickly hardens. The next layer of the liquid or molten material is applied to a hardened layer. The real copy of the polar plate is thus created layer by layer.

In a first embodiment of the process according to the invention, the print material is in the form of a filament. In this case, the composite is pressed through the nozzle (extruder) using an FFF process.

Preferably, the application is effected by depositing individual webs of the filament. The shape of the resulting polar plate is also determined by this.

Alternatively, the print material is in the form of a granular material. In this case, the print material is conveyed through the nozzle (extruder) using an FGF process. This is done, for example, via a conveying screw arranged on the extruder.

In addition to the actual print material, the composite preferably also contains binder which makes the material first printable and adhesive. This binder must be removed before the actual sintering.

The composite may comprise polymers, preferably thermoplastics and/or thermoplastic elastomers and/or metallic constituents or ceramic constituents.

Examples of metallic constituents are a vanadium-alloyed steel having at least 0.1% vanadium, noble metal-alloyed steel having at least 0.1% of a noble metal (e.g. gold, silver, and/or platinum) and aluminum-alloyed steel having at least 0.1% aluminum and all combinations thereof.

Alternatively, the composite or the metallic constituent of the composite consists only of a single metal present in elemental form and selected from the group of gold, silver, chromium, iron, copper, aluminum, zinc, nickel, platinum, cesium, tungsten, osmium, mercury, lead or tin.

Particularly suitable as a metal alloy for polar plates are hydrogen-stable steels having at least 0.1% vanadium. These include, for example, V4A steels. Here, V4A represents the CrNiMo steels 1.4401, 1.4571 and 1.4404. Ultrafuse 316L (BASF) is a particularly suitable composite.

If the composite is in the form of a filament, this may comprise at least one polymer and at least one metal or be formed only of metallic components. If the composite from step I contains a binder, the next step Ib is thus the debindering.

Ia. Debindering

In debindering, a large part of the binder in the first stage is removed by catalytic decomposition, by thermal vaporization, decomposition or by solvent extraction. Typical debindering is effected at 120° C. with formaldehyde HNO (<98%). During the debindering, the component may shrink geometrically.

### II. Sintering

Sintering is a process for the production or modification of materials. Fine-grained ceramic or metallic materials are heated, with, however, the temperatures remaining below the melting temperature of the main components, so that the form (shape) of the workpiece is retained.

The sintering should be effected in an atmosphere comprising 100% clean and dry hydrogen (dew point >−40° C.) or argon (dew point >−40° C.). The material for the sinter supports is preferably Al₂O₃ of, for example, 99.6% purity.

A typical sintering cycle consists of
1. a first heating period at temperatures from 20° C. to 600° C. with a rate of 5 K/min
2. a rest phase of 1h at a temperature of 600° C.
3. a second heating period from 600° C. to 1380° C. with a rate of 5 K/min
4. a sintering period of 3h at 1380° C.
5. cooling period from 1380° C. to 20° C.

During the sintering, the residues of the binder react with the remaining constituents of the print material and with the gas atmosphere and are thermally decomposed.

In the first heating period of the sintering process, the remaining binder constituents are thus incinerated and the pyrolysis products are removed by an extractor fan. The gas atmosphere can react with the print material such that it reduces oxides or removes carbon. The various reactions of the print material and the binder residue, and also between the print material and the atmosphere, often influence the mechanical and chemical properties of the sintered components, often via the carbon content in the structure.

By using the FFF process or FGF process, installation space-optimized fuel cells can be produced. This allows both a feedthrough through the fuel cell for, for example, mechanical or electrical and also fluid systems. In addition, blind media connections, for example, can be integrated directly into the component. By using a relatively inexpensive printer based on the FFF or FGF process, the advantages of design freedom can be utilized, the costs for a conventional powder-based 3D printer can be avoided and installation space-optimized fuel cells can be produced in any series size. This fuel cell is shown by way of example in FIG. 2.

By directly converting a 3D model into a finished fuel cell, any 3-dimensional structure of a fuel cell can thus be produced (wound, twisted, without any symmetry). The polar plates can utilize this design freedom in x,y, and z axis and can be adapted to the requirements in an installation space-optimized manner (optimized packaging). Furthermore, internal fluid channels (e.g. media and cooling channels) can be adapted without restrictions. Since 3D printing is not tied to a shaping mother mold, any desired series sizes can be individually adapted according to need. In particular, fuel cells can be developed which, in addition to the actual function of energy generation, are also an existing part of the supporting structure. Thus, the fuel cell itself can become part of a supporting frame or the like and components can be installed directly into the frame. In addition to concave or convex fuel cells, twisted or rotated fuel cells are also possible, which can be incorporated into a structure according to need and are optimized in terms of power according to the application. Furthermore, cooling channels of the fuel cell, for example, can be adapted according to need as a supply for a secondary application. Furthermore, a tapering of the channel within the x-y plane and also an x or y and z plane can be introduced within the flow field according to need, in order for example to generate or reduce pressure peaks within the fuel cell or to adjust flow velocities. By adjusting the infill, fuel cells can be produced with very low weight. Infill refers to the amount of material to be used inside the desired 3D model.

The polar plate produced by means of the process according to the invention is preferably configured such that it has at least a specific conductance of

$$> 0.005 \frac{m}{Ω {mm}^{2}} ,$$

measured at 20° C., preferably a specific conductance of

$$> 0.1 \frac{m}{Ω {mm}^{2}} ,$$

measured at 20° C., particularly preferably a conductance of

$$> 1 \frac{m}{Ω {mm}^{2}} ,$$

measured at 20° C.

### EXEMPLARY EMBODIMENTS

In a preferred embodiment of the polar plate produced by means of the process according to the invention, said polar plate comprises at least one internal channel through which fluid can flow. This is shown by way of example in FIG. 4a. This channel serves either to transport reaction fluids (e.g. H₂, H₂O, O₂, CH₄, etc.) or coolants. The cross section of the channel can be selected freely. This can be rectangular, square, round, ellipsoid or free-formed and can also be adapted in a manner optimized to needs both in cross section and shape.

If the composite is in the form of filaments, the filament diameter is preferably 1 mm to 4 mm. Typical filament diameters are 1.75 mm or 2.85 mm. Depending on the nozzle used, this leads to a layer thickness of typically 0.05 mm to 1 mm, with larger layer thicknesses also being possible.

If the composite is in the form of a granular material, the usual granule diameter is 0.5 mm to 10 cm, preferably 1 mm to 50 mm, particularly preferably 2 mm to 3 mm. Likewise, the granular material can also be present in cylindrical form, with the length then being between 0.1 mm and 10 cm, preferably 1 mm to 50 mm, particularly preferably 2 mm to 3 mm.

A typical composite for producing polar plates by the process according to the invention comprises a metal or a metal alloy which has been embedded into a polymer matrix, preferably into a thermoplastic polymer matrix. The metal serves here as print material and the polymer matrix as binder. Suitable in principle, therefore, are the commercial metal-polymer composite filament for production of metal parts from an austenitic stainless steel of 316L type with standard FFF printer systems and subsequent debindering and sintering processes customary in the industry. Further metal-plastic filaments such as for example copper, bronze, brass, gold, silver, and aluminum filament and any combinations or alloys and, in the case of the FGF process, the granular material forms thereof, can also be processed with this process. Furthermore, a combination of metal filament and ceramic filament and also pure ceramics and the granular material forms thereof is equally conceivable.

Various embodiment variants are shown in FIGS. 2 to 5. FIG. 2 shows a construction of a monocell system. The housing consists of a 3D-printed thermoplastic, the gaskets consist of a 3D-printed thermoplastic elastomer, with suitable thermoplastics such as for example polypropylene or polyethylene and also mixtures of various polypropylenes and polyethylenes also being suitable. The monopolar plate consists of a metal filament, which is sintered to give the final monopolar plate in the later sintering process. Internal channels can—if required—be filled by means of water-soluble support structures (BVOH, PVA and others) and dissolved out directly after the printing process by means of water or a suitable solvent.

FIG. 3 shows the schematic construction of the fuel cell as a multi-cell system. The housing here contains at least one thermoplastic, the gasket a thermoplastic elastomer (TPU, TPE or others). The polar plate shown in FIG. 3 was manufactured in analogous fashion to the monopolar plate shown in FIG. 2. FIG. 4a shows the internal fluid channels, which can take any desired and optimized cross sections. FIGS. 4b and 4c show examples of different designs of the polar plates with internal fluid channels. Here, the variant of FIG. 4b is suitable as an angle bracket, which can be used in construction to connect two elements and also fulfills the function of the energy supply. The variant from FIG. 4c shows an annular fuel cell. This fuel cell permits the attachment to a pipeline and can, for example, serve directly as a heat exchanger. Furthermore, this design is suitable as a support structure with high strength and low weight, for example for use in the aerospace industry. FIGS. 5a and 5b show a polar plate stack with a plurality of feedthroughs for example for mechanical structures or electrical lines and also media conduits. It is clarified here that a fuel cell produced with the process according to the invention can assume any desired structure and fits into an existing structure according to need and in a space-optimized manner.

### FIGURE LEGENDS AND LIST OF REFERENCE SIGNS

FIG. 1 Schematic structure of a PEM fuel cell (prior art)

FIG. 2 Construction of a fuel cell with the monopolar plate according to the invention

FIG. 3 Construction of a fuel cell with the polar plate according to the invention

FIGS. 4 a to c Various variants of a polar plate with internal channels

FIGS. 5 a to b Various variants of a stack with internal feedthroughs for mechanical or electrical structures

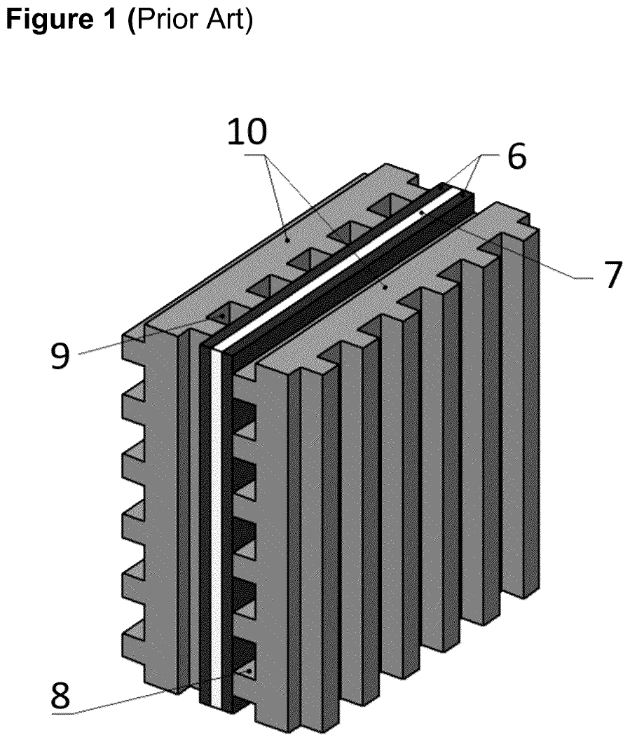

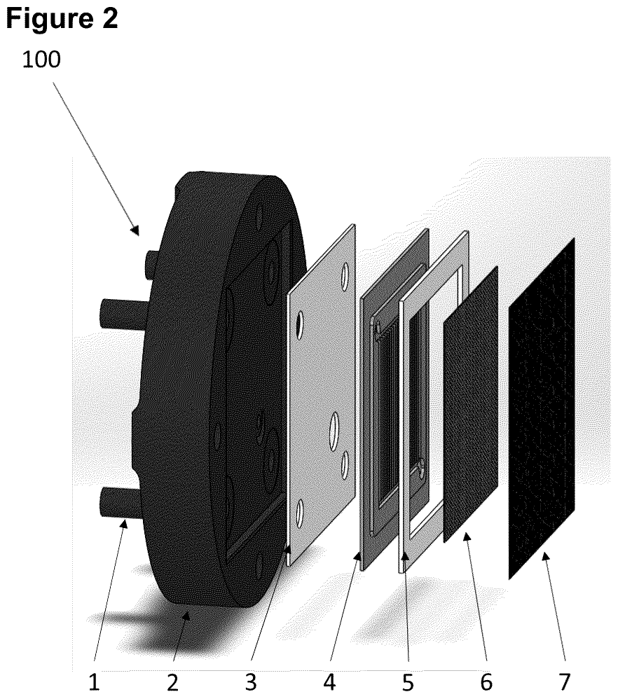

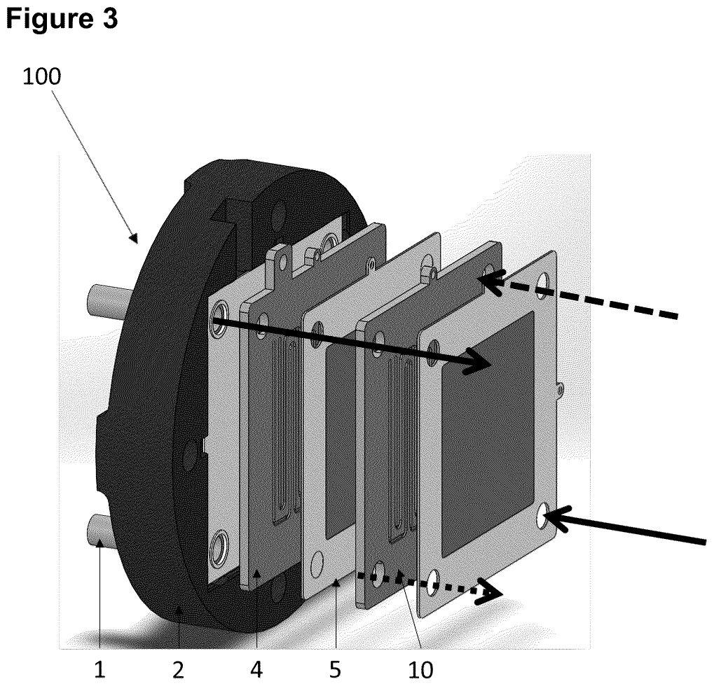

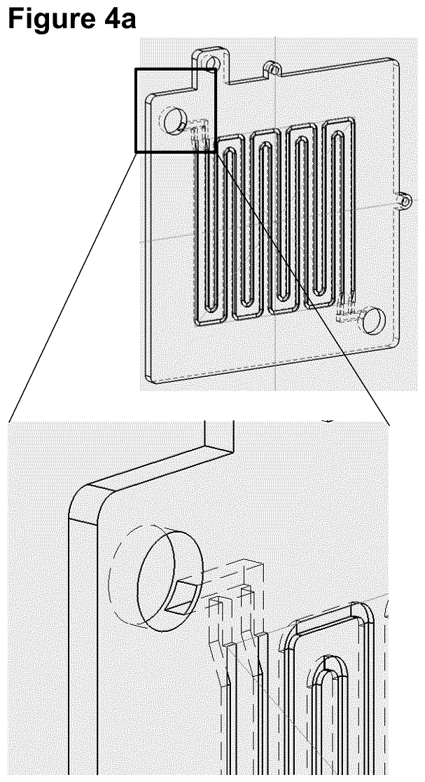

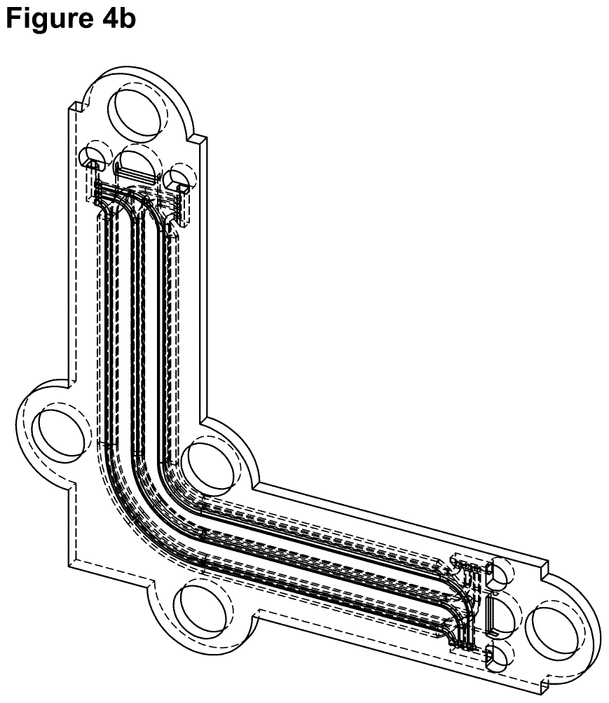

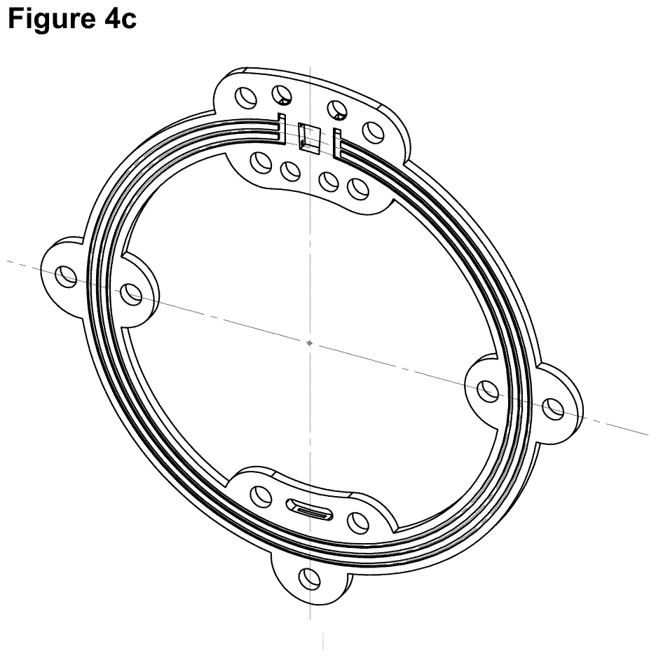

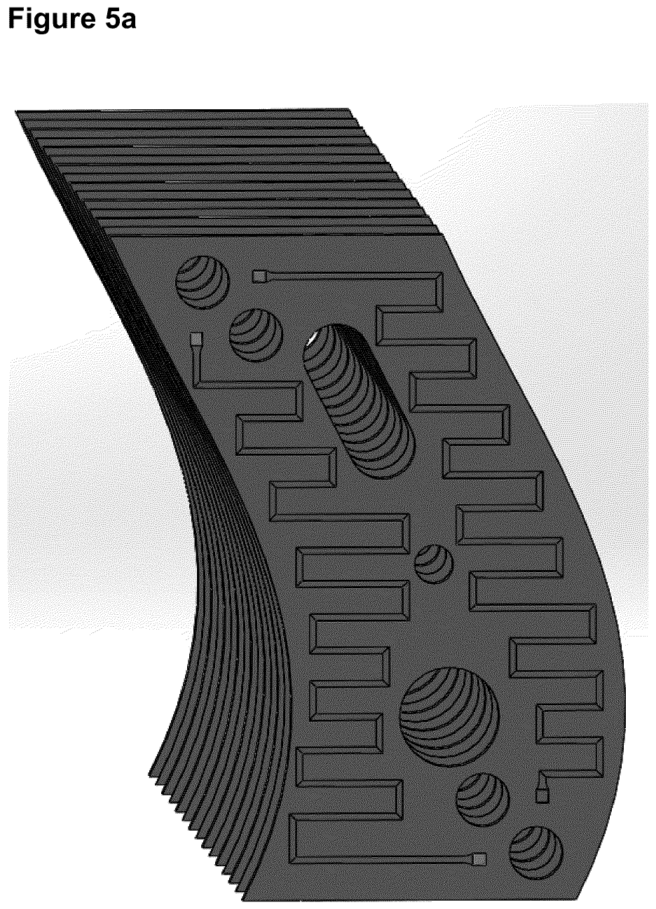

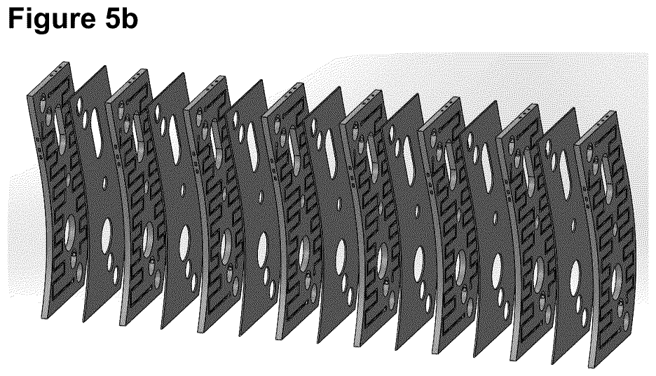

### REFERENCE SIGNS

1 Media connections
2 End plate
3 Media connection gasket
4 Monopolar plate
5 Flow field gasket
6 Gas diffusion layer
7 Proton exchange membrane
8, 9 Fluid channel
10 Polar plate
100 Fuel cell

[symbol] Hydrogen flow

Air flow

1. A process for producing a polar plate for fuel cells and/or redox flow batteries, comprising:
I. applying a composite comprising a print material layer-by-layer through a nozzle using a fused filament fabrication (FFF) process or a fused granular fabrication (FGF) process onto a work plane to produce a blank of the polar plate, and
II. sintering the blank of the polar plate from step I, wherein temperatures during sintering remain below a melting temperature of the print material, so that a form of a workpiece is retained to produce a finished polar plate.

2. The process as claimed in claim 1, wherein the composite further comprises a binder, wherein after step I and before step II, a predominant portion of the binder is removed from the blank of the polar plate by catalytic decomposition, thermal vaporization, decomposition, or solvent extraction.

3. The process as claimed in claim 1, wherein the composite is in the form of a filament.

4. The process as claimed in claim 3, wherein the composite is applied by depositing individual material webs.

5. The process as claimed in claim 1, wherein the composite is in the form of a granular material.

6. The process as claimed in claim 1, wherein the composite comprises at least one polymer.

7. The process as claimed in any of claim 1, wherein the composite comprises a metal constituent.

8. The process as claimed in claim 7, wherein the metal constituent comprises a vanadium-alloyed steel having at least 0.1% vanadium.

9. The process as claimed in claim 7, wherein the metal constituent comprises a noble metal-alloyed steel having at least 0.1% of a noble metal.

10. The process as claimed in claim 7, wherein the metal constituent comprises an aluminum-alloyed steel having at least 0.1% aluminum.

11. The process as claimed in claim 1, wherein the composite consists of an elemental metal selected from gold, silver, copper, aluminum, zinc, nickel, platinum, or tin.

12. A polar plate produced by the process as claimed in claim 1.

13. The polar plate as claimed in claim 12, comprising at least one internal channel through which fluid can flow.

14. A fuel cell comprising at least one polar plate as claimed in claim 12.

15. A redox flow battery comprising at least one polar plate as claimed in claim 12.

16. The process of claim 1, wherein applying the composite comprises printing the composite.
